(19) United States
(12) Patent Application Publication
(10) Pub. No.: US 2026/0120474 A1
(43) Pub. Date: Apr. 30, 2026

(54) TRAFFIC ACCIDENT SCENE ANALYSIS SYSTEM

(71) Applicant: FENG CHIA UNIVERSITY, Taichung City (TW)

(72) Inventors: Yu-Chen LIN, Taichung City (TW); Wei-Hsiang HUANG, Taichung City (TW); Hao-Wei CHANG, Taichung City (TW); Yu-Ping SU, Taichung City (TW)

(73) Assignee: FENG CHIA UNIVERSITY, Taichung City (TW)

(21) Appl. No.: 18/958,846

(22) Filed: Nov. 25, 2024

(30) Foreign Application Priority Data
Oct. 24, 2024 (TW) 113140657

(51) Int. Cl. G06V 20/54; G06F 40/279; G06T 7/10; G06T 13/00; G06V 10/26

(52) U.S. Cl. CPC G06V 20/54; G06F 40/279; G06T 7/10; G06T 13/00; G06V 10/26; G06V 2201/08

(57) ABSTRACT

A traffic accident scene analysis system comprises a camera unit, an input unit, a user interface, and a computation unit electrically connected to the camera unit, the input unit, and the user interface. The camera unit captures and outputs a scene image of an accident, the input unit inputs a record information, the computation unit performs image segmentation on the scene images to generate information of at least one accident-causing vehicle and a road information, and the computation unit performs word segmentation on the record information to generate plural keyword information; the computation unit executes program data of a generative artificial intelligence model that generates a preliminary analysis report of the accident, based on the information of the at least one accident-causing vehicle, the road information, and the plural keyword information; the preliminary analysis report comprises an animation of the accident.

### CROSS REFERENCE TO RELATED APPLICATION(S)

This application claims the priority to patent application No. 113140657 filed in Taiwan on Oct. 24, 2024, which is hereby incorporated in its entirety by reference into the present application.

### BACKGROUND OF THE INVENTION

### 1. Field of the Invention

The present invention relates to an analysis system, in particular, to a traffic accident scene analysis system using artificial intelligence (AI).

### 2. Description of the Related Art

In order to make life more convenient and mobile, people nowadays rely on cars, motorcycles, bicycles and other means of transportation, but also encounter a lot of traffic accidents; when a traffic accident occurs and after a report of the accident is received, the police will arrive at the scene of the accident to measure relevant positions of the accident vehicle(s), ask the parties involved in the accident to make a record, and use the results of the on-site measurements and the record to prepare a traffic accident preliminary analysis judgement table (or simply: Preliminary Judgement Table). Based on the Preliminary Judgement Table, the parties can settle the case, file insurance claims and carry out other subsequent procedures.

However, the relevant positions of the accident vehicle(s) at the scene usually need to be measured manually by a police officer holding a rangefinder, and since the accident vehicle is not allowed to move before the measurement is completed, and if the traffic accident occurs on a main road with heavy traffic, the police officer will be exposed to the hazardous environment during the process of measuring the relevant positions of the accident vehicle(s); in addition, the police have to spend a lot of time sorting out how the road accident happened, such as drawing accident scene maps based on the measurement results, and making the record for filing, etc., before completing the Preliminary Judgement Table, which on one hand consumes police manpower and resources, and on the other hand delays the process of settlement and insurance claims by the parties involved in the accident.

### SUMMARY OF THE INVENTION

When a traffic accident occurs, existing accident analysis methods have problems as described in the prior art, in view of which, the present invention proposes a traffic accident scene analysis system comprising:
a camera unit for capturing and outputting scene images of an accident involving at least one accident-causing vehicle;
an input unit for inputting a record information;
a computation unit electrically connected to the camera unit and the input unit for receiving the scene images and the record information, the computation unit performing image segmentation on the scene images to generate information of the at least one accident-causing vehicle and a road information, and the computation unit performing word segmentation on the record information to generate plural keyword information; the computation unit executing program data of a generative artificial intelligence model that generates a preliminary analysis report of the accident based on the information of the at least one accident-causing vehicle, the road information, and the plural keyword information; the preliminary analysis report comprising an animation of the accident; and
a user interface electrically connected to the computation unit, and the user interface receiving and displaying the preliminary analysis report.

When a traffic accident occurs, the camera unit of the traffic accident scene analysis system of the present invention can be operated by a user (a police officer) to capture images of the scene of the traffic accident to output the scene images of the traffic accident, and the input unit can be operated to input the record information according to statements of the parties involved in the accident. Subsequently, the computation unit processes the scene images and the record information respectively, and then generates a preliminary analysis report including an animation of the accident based on the above processing result via a generative artificial intelligence model, and displays the preliminary analysis report via the user interface. The accident scene analysis system of the present invention has the effect of reconstructing the scene of the accident, and the preliminary analysis report can be used as a reference for the relevant personnel (e.g., the forensic personnel, the judge) for the purpose of forensic investigation or adjudication. Compared with the prior art, in the present invention, the police officer does not need to hold a distance measuring device to manually measure the relevant positions of the vehicles involved in the accident, thus reducing the time the police are exposed to the hazardous environment, and the computation unit can automatically produce the preliminary analysis report, thus saving the manpower of the police. The generic artificial intelligence model can produce the preliminary analysis report faster than humans, which facilitates the parties involved in the accident to go promptly through the subsequent relevant processes.

In order to make the above objects, features and advantages of the present invention more apparent and easier to understand, the following embodiments, together with the accompanying drawings, are described in detail as follows.

### BRIEF DESCRIPTION OF THE DRAWINGS

FIG. 1 illustrates a block diagram of the traffic accident scene analysis system of the present invention;

FIG. 2 illustrates a schematic diagram of a scene image in the traffic accident scene analysis system of the present invention;

FIG. 3 illustrates a block diagram of the traffic accident scene analysis system;

FIG. 4 illustrates a schematic diagram of a scene image via image segmentation in the traffic accident scene analysis system of the present invention;

FIG. 5 illustrates a scene schematic in the preliminary analysis report generated by the traffic accident scene analysis system;

FIG. 6 illustrates a schematic diagram of a scene image in the traffic accident scene analysis system of the present invention, which includes a simulated track of an accident-causing vehicle; and

FIG. 7 illustrates a block diagram of the traffic accident scene analysis system of the present invention.

### DETAILED DESCRIPTION OF THE INVENTION

The technical solution of the present invention is further described below in conjunction with the accompanying drawings and by means of specific embodiments. In the description of the present invention, it is to be understood that the terms “center”, “longitudinal”, “lateral”, “length”, “width”, “thickness”, “top”, “bottom”, “left”, “right”, “vertical”, “horizontal”, “top”, “bottom”, “inner”, “outer”, “axial”, “radial”, “circumferential” and the like indicate orientation or positional relationships based on those shown in the accompanying drawings, and are intended only to facilitate the description of the present invention and to simplify the description, and are not intended to indicate or imply that the device or element referred to must have a particular orientation, or be constructed and operated in a particular orientation and therefore cannot be construed as limitations of the present invention.

Furthermore, the terms “first” and “second” are used for descriptive purposes only and are not to be understood as indicating or implying relative importance or implicitly specifying the number of technical features indicated. Thus, the feature defined with “first”, “second” may include one or more such features, either explicitly or implicitly. In the description of the present invention, unless otherwise specified, “more than one” means two or more.

In the description of the present invention, it is to be noted that, unless otherwise expressly specified and limited, the terms “mounted”, “connected”, and “connecting” are to be understood in a broad sense. For example, it may be a fixed connection, a removable connection, or a connection in one piece; it may be a direct connection, an indirect connection through an intermediate medium, or a connection within two elements. For a person of ordinary skill in the art, the specific meaning of the above terms in the present invention may be understood in a specific context.

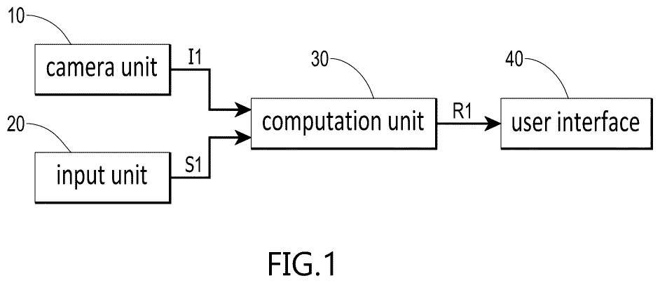

Referring to FIG. 1, a traffic accident scene analysis system of the present invention comprises a camera unit 10, an input unit 20, a computation unit 30 and a user interface 40, wherein the computation unit 30 is electrically or communicatively connected to the camera unit 10, the input unit 20, and the user interface 40.

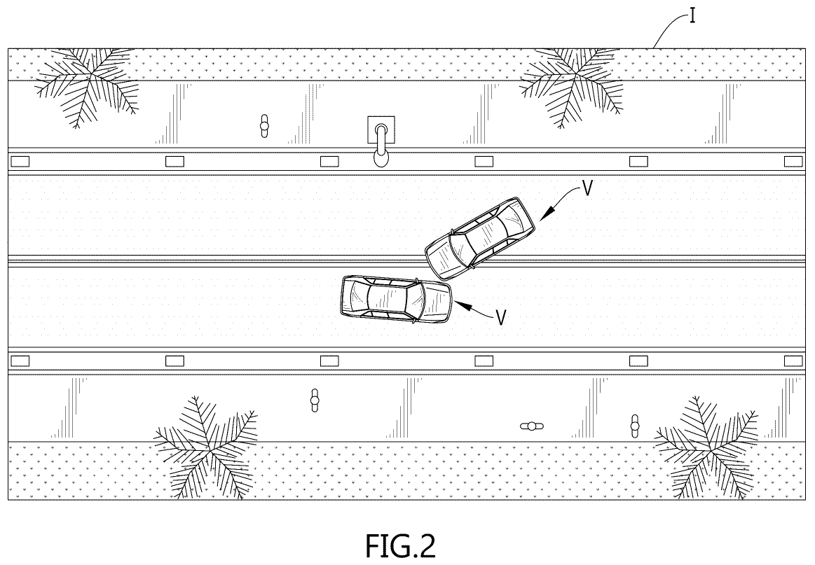

As shown in FIG. 2, the camera unit 10 is used to capture images of the accident scene to output scene images I1, and the scene images I1 include at least one accident-causing vehicle V. For example, the camera unit 10 may be an aerial camera which, when the police who are notified of an accident and arrive at the scene of the accident, may operate the aerial camera in an off-road area so that the aerial camera flies over the scene of the accident to take photographs including the at least one accident-causing vehicle V; or the camera unit 10 comprises a camera lens and a microprocessor (MCU), the camera lens is electrically connected to the microprocessor, and a police officer can also operate the camera lens in an off-road area to capture a side view image comprising the at least one accident-causing vehicle V, and the microprocessor receives the side view image and performs image processing thereof to convert the side view image into a top view scene image I1. The OpenCV library can be used to help the microcontroller convert the images I1 from side view to top view, but as specific conversion processes are not the technical focus of the camera unit 10, they will not be described in detail herein.

The input unit 20 is used to input a record information S1, for example, the input unit 20 may be a mobile device such as a smart phone, a tablet computer, etc. with text input means (e.g., input via a touch display screen), or the input unit 20 may be a computer with text input function (e.g., input via a keyboard, or a mouse); however, the present invention is not limited to the specific examples given above; the police may input the record information S1 based on the statements of the parties involved in the accident by operating the input unit 20.

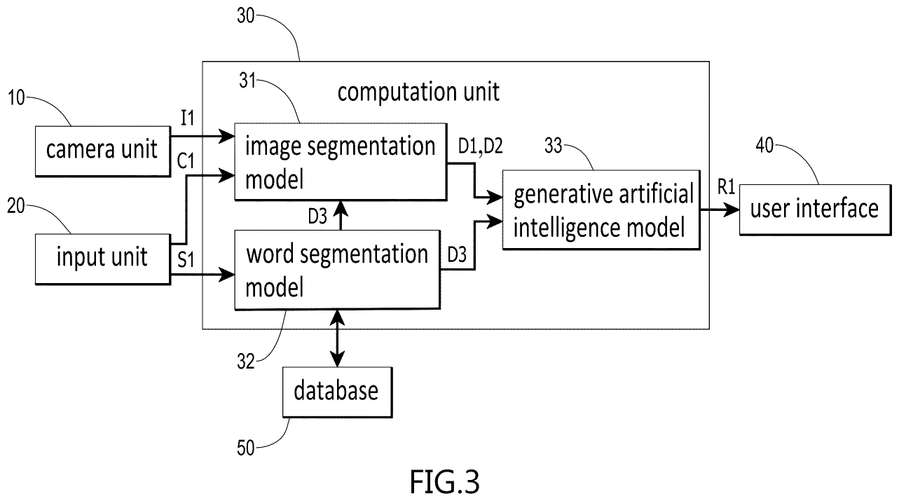

Referring to FIGS. 1 and 3, the computation unit 30 receives the scene images I1 and the record information S1, and performs image segmentation on the scene images I1 to generate information of the at least one accident-causing vehicle D1 and a road information D2. The information of the at least one accident-causing vehicle D1 comprises, for example, information such as a vehicle size, a vehicle color, a vehicle type, etc. of the accident-causing vehicle V. The road information D2 is information about the road on which the accident occurred, such as road markings on the road and a width of the road.

The computation unit 30 performs word segmentation on the record information S1 to generate plural keyword information D3, for example, the computation unit 30 may be a computing device such as a server, a computer, etc., and taking the computation unit 30 as an example of a server, the server has plural web portals, and one of the plural web portals is used to receive information. Therefore, the scene images I1 captured by the camera unit 10 can be transmitted to the server (i.e. the computation unit 30) via the web portal, and the record information inputted via the input unit 20 can also be transmitted to the server (i.e. the computation unit 30) via the web portal.

Specifically, the computation unit 30 may execute program data of an image segmentation model 31 and a word segmentation model 32, the image segmentation model 31 is connected to the word segmentation model 32, and the image segmentation model 31 may perform semantic segmentation or instance segmentation on the scene images I1 to segment the information of the at least one accident-causing vehicle D1 and the road information D2, for example, the image segmentation model 31 may be a Mack R-CNN model, a YOLACT model, a SOLO model, a BlendMask model, and the like; however, the present invention is not limited to the specific examples given above. The detailed computational process of the image segmentation model 31 performing the semantic segmentation or the instance segmentation is not the technical focus of the present invention and will not be described in detail herein.

The word segmentation model 32 can be, for example, the Chinese word segmentation model (Jeiba). The word segmentation model 32 is based on the dictionary tree structure (Trie Tree) to generate all scenarios that all words in the record information S1 can become phrases, and then uses the dynamic programming algorithm to find out plural maximum probability paths that are the plural keyword information D3, the detailed computing process of how the word segmentation model 32 captures the plural keyword information D3 in the record information S1 is not the technical focus of the present invention, and will not be described in detail herein.

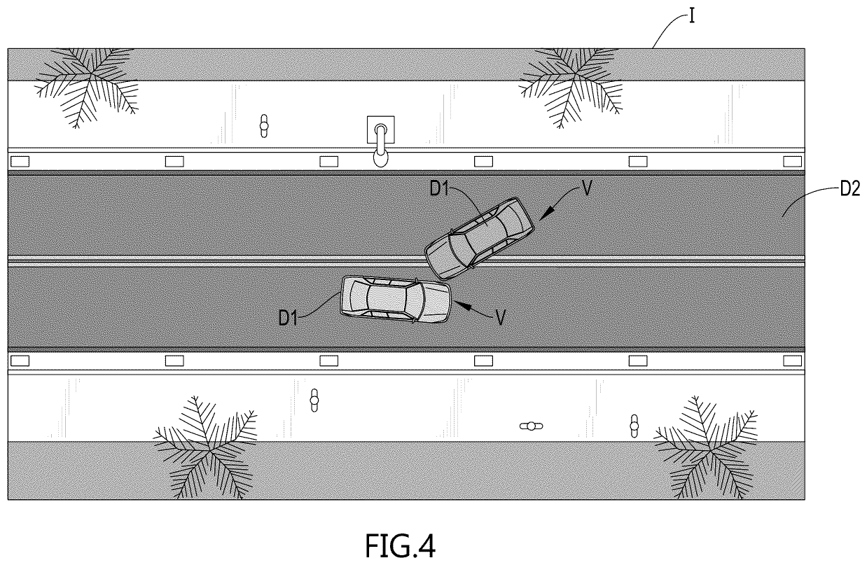

Referring to FIG. 4, since the scene images I1 may include other vehicles (not shown), the computation unit 30 must distinguish between the at least one accident-causing vehicle V and other unrelated vehicles when performing image segmentation. In an embodiment of the present invention, the image segmentation model 31 generates the information of the at least one accident-causing vehicle D1 by performing instance segmentation, specifically, the image segmentation model 31 receives the plural keyword information D3, and then performs instance segmentation on the scene images I1 based on the plural keyword information D3 to generate the information of the at least one accident-causing vehicle D1. For example, if the description of the at least one accident-causing vehicle V in the plural keyword information D3 includes “white”, “recreation vehicle (RV)”, etc., then the image segmentation model 31 segments vehicles in the scene images I1 that match the plural keyword information D3 as the information of the at least one accident-causing vehicle D1.

Alternatively, the at least one accident-causing vehicle V in the scene images I1 may be a first accident-causing vehicle and a second accident-causing vehicle, and the image segmentation model 31 also performs instance segmentation on the plural keyword information D3 to get a first accident-causing vehicle and a second accident-causing vehicle; in addition, in this embodiment, the computation unit 30 may perform natural language processing on the record information S1 and then execute the word segmentation model 32 to generate the plural keyword information D3 based on the record information S1 which is processed by the natural language processing.

In another embodiment of the present invention, the image segmentation model 31 generates the information of the at least one accident-causing vehicle D1 by semantic segmentation and at least one recognition instruction C1, in particular, the image segmentation model 31 performs semantic segmentation over the scene images I1 to generate the information of the at least one vehicle, which must be further defined by the at least one recognition instruction C1 to generate the information of the at least one accident-causing vehicle D1, since the at least one vehicle information may be information of an unrelated vehicle. The at least one recognition instruction C1 is generated by a user operating the input unit 20, for example, as described above, the input unit 20 may be a touch display screen of a tablet PC, and when the image segmentation model 31 performs semantic segmentation on the information of the at least one vehicle, the tablet PC may display the information of the at least one vehicle for the user to touch to generate the at least one recognition instruction C1, which is transmitted to the computation unit 30 to cause the image segmentation model 31 to generate the information of the at least one accident-causing vehicle D1 based on the at least one recognition instruction C1.

Referring again to FIG. 2, the computation unit 30 can execute program data of a generative artificial intelligence (GAI) model 33 that generates a preliminary analysis report R1 of the accident based on the information of the at least one accident-causing vehicle D1, the road information D2, and the plural keyword information D3, wherein the preliminary analysis report R1 comprises an animation of the accident, e.g., the generative artificial intelligence model may be a variational autoencoder (VAE), a generative adversarial network (GAN), a diffusion model, a large language model (LLM), and so on, and in one embodiment of the present invention, the invention mainly uses the GPT-3 among the LLMs as the generative artificial intelligence model 33. The detailed computation process of the generative artificial intelligence model 33 is common knowledge in related technical fields, which is not described herein.

The user interface 40 receives and displays the preliminary analysis report R1; for example, the user interface 40 may be displayed on a device such as a smartphone, a tablet, a computer, etc. In the case where the user interface 40 is displayed on a smartphone, the computation unit 30 is a server having plural web portals as described above, one of the plural web portals is used to display the user interface 40, and the smartphone may be connected to the web portal to display the preliminary analysis report R1.

In one embodiment of the present invention, the computation unit 30 is electrically connected to a database 50, which is built by means of Structured Query Language (SQL), and stores the information of the accident-causing vehicle D1, road information D2, plural keyword information D3, and preliminary analysis report R1 of various accidents. This means that the database 50 has a complete relational database management system architecture for integrating and managing the relevant information of different accidents.

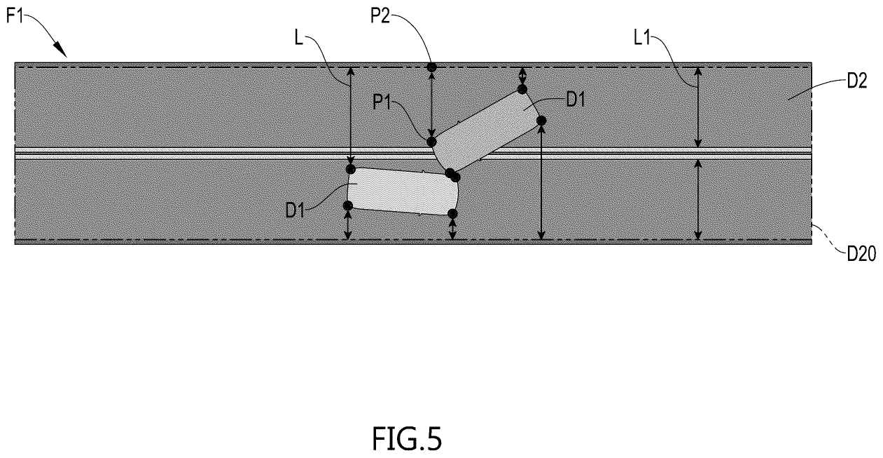

Referring to FIG. 5, the preliminary analysis report R1 may include a scene schematic F1, the scene schematic F1 includes plural reference distances L, and the plural reference distances L include the distance between at least one reference point coordinate P1 and at least one road marking coordinate P2. In particular, the generative artificial intelligence model 33 generates the at least one reference point coordinate P1 of each accident-causing vehicle V. The at least one reference point coordinate P1 may correspond, for example, to the positions of the front end, the rear end, etc. of each accident-causing vehicle, and the image segmentation model 31 may generate the at least one road marking coordinate P2 of a road based on the scene images I1 during image segmentation, i.e., the at least one road marking coordinate P2 is included in the road information D2, and subsequently the generative artificial intelligence model 33 may automatically calculate the distance between the at least one reference point coordinate P1 and the at least one road marking coordinate P2.

Since the plural reference distances L are automatically generated by the generative artificial intelligence model 33, the plural reference distances L may not meet the requirements of an actual situation, so that when the generative artificial intelligence model 33 finishes computing the plural reference distances L, it may then display the plural reference distances L via the aforementioned tablet PC, the PC, the smartphone, etc. for the user to touch to adjust the at least one reference point coordinate P1, so that the generative artificial intelligence model 33 corrects the plural reference distances L.

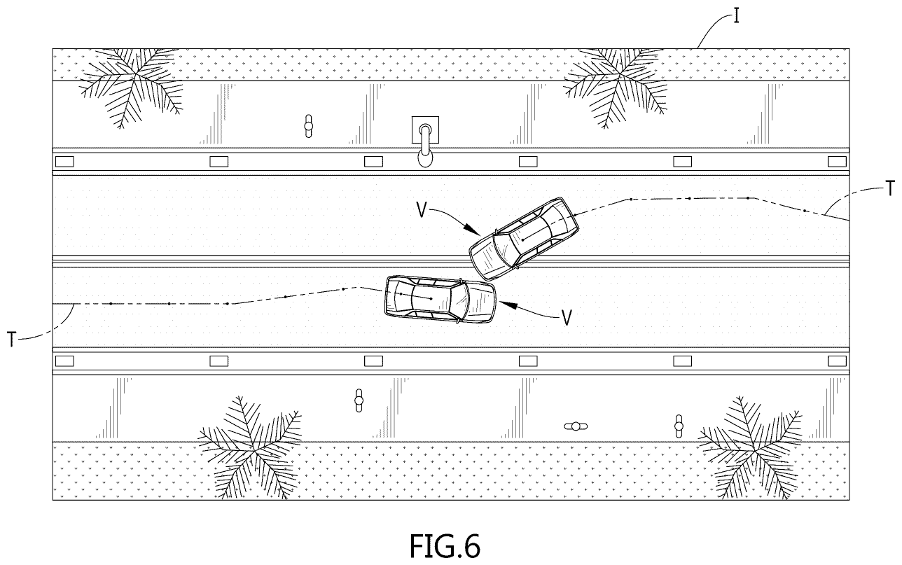

Further, the road information D2 may comprise a range of road D20, as shown in FIG. 6, the generative artificial intelligence model 33 may generate a simulated track T of the accident-causing vehicle V based on the plural keyword information D3, and the generative artificial intelligence model 33 determines whether the simulated track T is within the range of road D20 as shown in FIG. 5; when the generative artificial intelligence model 33 determines that the simulated track T is within the range of road D20, the generative artificial intelligence model 33 generates an animation of the accident and outputs it to the user interface 40, based on the information of the at least one accident-causing vehicle D1, the road information D2 and the simulated track T, so that the user interface 40 receives and displays the animation of the accident, and conversely, when the generative artificial intelligence model 33 determines that the simulated track T is not within the range of road D20, the generative artificial intelligence model 33 re-calculates the simulated track T.

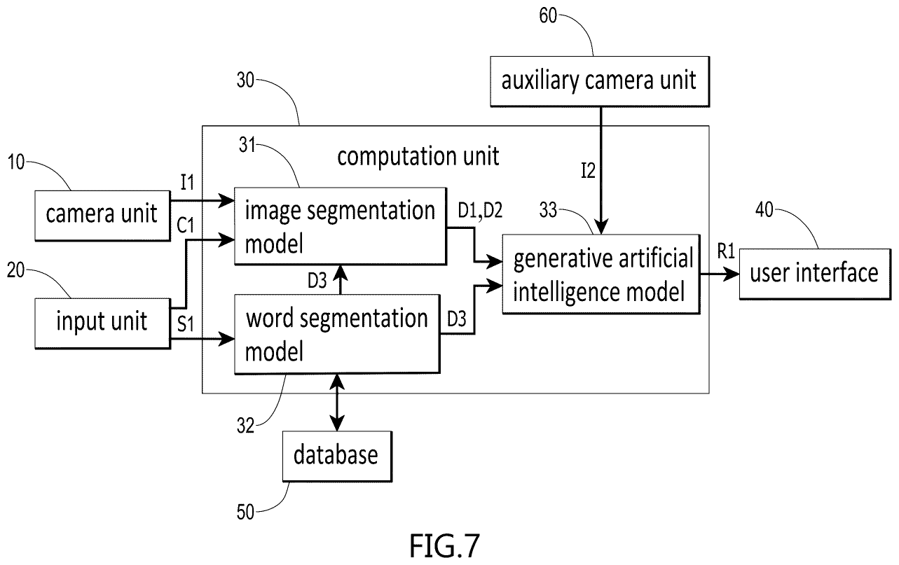

Referring to FIG. 7, in one embodiment of the present invention, the traffic accident scene analysis system further comprises an auxiliary camera unit 60, which is electrically connected to the computation unit 30 and captures the occurrence process of the accident to generate images of the accident I2, for example, the auxiliary camera unit 60 may be a dashboard camera, a surveillance camera, etc., and the images of the accident I2 may be transmitted to the server (the computation unit 30) through one of the plural web portals, similar to the scene images I1 mentioned above. The generative artificial intelligence model 33 of the computation unit 30 receives the images of the accident I2 and generates the preliminary analysis report R1 of the accident based on the information of the at least one accident-causing vehicle D1, the road information D2, the plural keyword information D3, and the images of the accident I2.

When a traffic accident occurs, the camera unit 10 of the traffic accident scene analysis system of the present invention can be operated by a user (a police officer) to capture images of the scene of the traffic accident to output the scene images I1 of the traffic accident, and the input unit can be operated to input the record information S1 according to the statement of the parties involved in the accident. Subsequently, the computation unit 30 processes the scene images I1 and the record information S1 respectively, and then generates a preliminary analysis report R1 including an animation of the accident based on the above processing result via a generative artificial intelligence model 33, and displays the preliminary analysis report R1 via the user interface 40. The accident scene analysis system of the present invention has the effect of reconstructing the scene of the accident, and the preliminary analysis report R1 can be used as a reference for the relevant personnel (e.g., the forensic personnel, the judge) for the purpose of forensic investigation or adjudication. Compared with the prior art, in the present invention, the police officer does not need to hold a rangefinder to manually measure the relevant positions of the vehicles in the accident, thus reducing the time the police are exposed to the hazardous environment, and the computation unit 30 can automatically produce the preliminary analysis report R1, thus saving the manpower of the police. The generic artificial intelligence model 33 can produce the preliminary analysis report R1 faster than humans, which facilitates the parties involved in the accident to go promptly through the subsequent relevant processes.

In summary, the above is only a record of the implementation of the technical means used in the present invention to solve the problem or an example of implementation, and is not intended to limit the scope of the patent of the present invention. It is not intended to limit the scope of the patent of the present invention, i.e., all changes and modifications that are consistent with the meaning of the scope of the patent application of the present invention or in accordance with the scope of the patent of the present invention are covered by the scope of the patent of the present invention.

The technical principles of the present invention are described above in connection with specific embodiments. These descriptions are only intended to explain the principles of the present invention, and are not to be construed in any way as a limitation on the scope of protection of the present invention. Based on the explanations herein, other specific embodiments of the present invention can be associated by those skilled in the art without creative labor, and these equivalent variations or substitutions are included in the scope limited by the claims of this application.

Although the present invention has been disclosed as above by way of a preferred embodiment, it is not intended to limit the present invention, and any one skilled in the art may make certain changes and modifications without departing from the spirit and scope of the present invention, and therefore the scope of protection of the present invention shall be subject to the scope of the appended patent claims as defined herein.

What is claimed is:

1. A traffic accident scene analysis system comprising:
a camera unit for capturing and outputting scene images of an accident involving at least one accident-causing vehicle;
an input unit for inputting a record information;
a computation unit electrically connected to the camera unit and the input unit for receiving the scene images and the record information, the computation unit performing image segmentation on the scene images to generate information of the at least one accident-causing vehicle and a road information, and the computation unit performing word segmentation on the record information to generate plural keyword information; the computation unit executing program data of a generative artificial intelligence model that generates a preliminary analysis report of the accident based on the information of the at least one accident-causing vehicle, the road information, and the plural keyword information, the preliminary analysis report comprising an animation of the accident; and
a user interface electrically connected to the computation unit, and the user interface receiving and displaying the preliminary analysis report.

2. The traffic accident scene analysis system as claimed in claim 1, wherein the computation unit executes program data of an image segmentation model and a word segmentation model, the image segmentation model is connected to the word segmentation model, the word segmentation model generates the plural keyword information based on the record information, and the image segmentation model performs instance segmentation of the scene images based on the plural keyword information to generate the information of the at least one accident-causing vehicle.

3. The traffic accident scene analysis system as claimed in claim 2, wherein the computation unit performs natural language processing on the record information and then executes the word segmentation model so that the word segmentation model generates the plural keyword information based on the record information which is processed by the natural language processing.

4. The traffic accident scene analysis system as claimed in claim 1, wherein the computation unit executes an image segmentation model, the image segmentation model receives at least one recognition instruction by the input unit, the image segmentation model performs semantic segmentation on the scene images, and generates the information of the at least one accident-causing vehicle based on the at least one recognition instruction.

5. The traffic accident scene analysis system as claimed in claim 1, further comprising an auxiliary camera unit which is electrically connected to the computation unit and capturing an occurrence process of the accident to produce images of the accident, wherein the generative artificial intelligence model of the computation unit receives the images of the accident, and the generative artificial intelligence model generates the preliminary analysis report of the accident based on the information of the at least one accident-causing vehicle, the road information, the plural keyword information, and the images of the accident.

6. The traffic accident scene analysis system as claimed in claim 1, wherein the generative artificial intelligence model generates at least one reference point coordinate for each accident-causing vehicle based on the plural keyword information, and the road information comprises at least one road marking coordinate;
the preliminary analysis report comprises a scene schematic, the scene schematic comprising plural reference distances, the plural reference distances comprising distances between the at least one reference point coordinate and the at least one road marking coordinate.

7. The traffic accident scene analysis system as claimed in claim 1, wherein the road information comprises a range of road, the generative artificial intelligence model generates a simulated track of the at least one accident-causing vehicle based on the plural keyword information, and the generative artificial intelligence model determines whether the simulated track is within the range of road;
when the generative artificial intelligence model determines that the simulated track is within the range of road, the generative artificial intelligence model generates the animation of the accident based on the information of the at least one accident-causing vehicle, the road information and the simulated track.

8. The traffic accident scene analysis system as claimed in claim 1, wherein the computation unit is electrically connected to a database constructed on the structured query language, the database storing the information of the at least one accident-causing vehicle, the road information, the plural keyword information, and the preliminary analysis report of various accidents.
